(19) United States
(12) Patent Application Publication
(10) Pub. No.: US 2013/0010121 A1
(43) Pub. Date: Jan. 10, 2013

(54) SYSTEM AND METHOD FOR ACCESSING PRODUCT DATABASE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/221,913

(22) Filed: Aug. 31, 2011

(30) Foreign Application Priority Data
Jul. 5, 2011 (TW) 100123598

(51) Int. Cl. H04N 5/225

(52) U.S. Cl. 348/207.1; 348/E05.048

(57) ABSTRACT

A method for accessing product database includes: storing a number of images of different products and information corresponding to each product; capturing an image of a product; comparing the image captured by the camera with the stored images to determine whether the image is the same as one of the stored images; and reading information of one product corresponding to the image when the image is the same as one of the stored images.

### BACKGROUND

1. Technical Field

The present disclosure relates to a system and method for accessing a database and in particular a database containing information about products for sale.

2. Description of Related Art

In stores, products offered for sale are often shrink-wrapped to protect them when handled by potential customers making it difficult for the customers to learn more about the product. Additionally, customers may want to know more information about a product than that shown on the packaging and no sales clerk is available to provide assistance.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a system for accessing product database.

FIG. 2 is a flowchart of an exemplary embodiment of a method for accessing product database.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

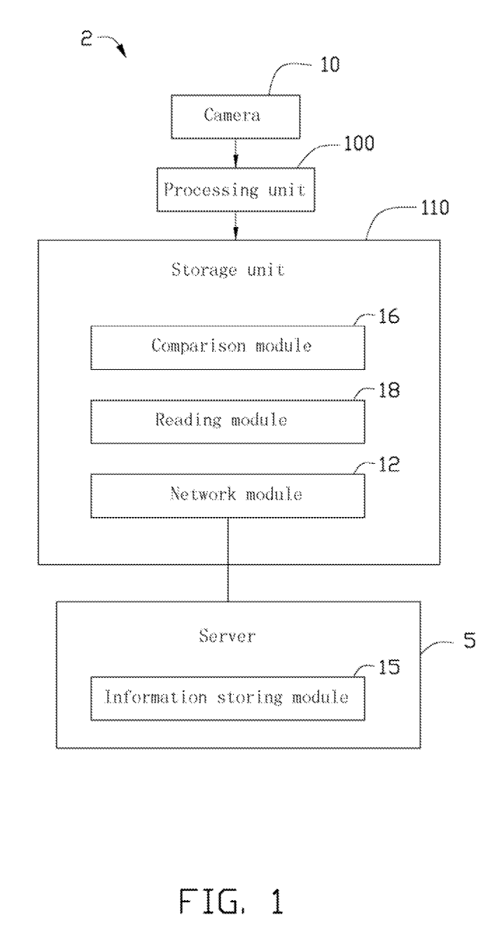

Referring to FIG. 1, an exemplary embodiment of a system 2 for accessing a product database is shown. The system 2 includes a camera 10, a processing unit 100 connected to the camera 10, a storage unit 110 connected to the processing unit 100, and an information storing module 15 which may include computer code to be executed by the processing unit 100. In the embodiment, the information storing module 15 is set in the server 5. The storage unit 110 includes a comparison module 16, a reading module 18, and a network module 12, which may include computer code to be executed by the processing unit 100. In the embodiment, the camera 10, the comparison module 16, the reading module 18, and the network module 12 are set in a handheld device, such as a mobile phone. The mobile phone communicates with the information storing module 15 through the network module 12.

For describing how the system 2 works, in this embodiment, the product is a book.

The information storing module 15 stores a plurality of images of covers of different books and information corresponding to each book. The information corresponding to each book includes a name, an author, a publisher, a summary, and a web link of the book.

The camera 10 can be used to capture an image of a cover of a book. The processing unit 100 processes the image captured by the camera 10 such that the image is in a format to be compared to other images. The comparison module 16 compares the image processed by the processing unit 100 with the images stored in the information storing module 15 through the network module 12. If the image is the same as one of the images stored in the information storing module 15, the reading module 18 reads the information corresponding to the image. The information is displayed on a screen of the mobile phone.

In other embodiments, if the handheld device has enough space to store the images and the information, the information storing module 15 can be set in the handheld device, in which case the network module 12 can be omitted.

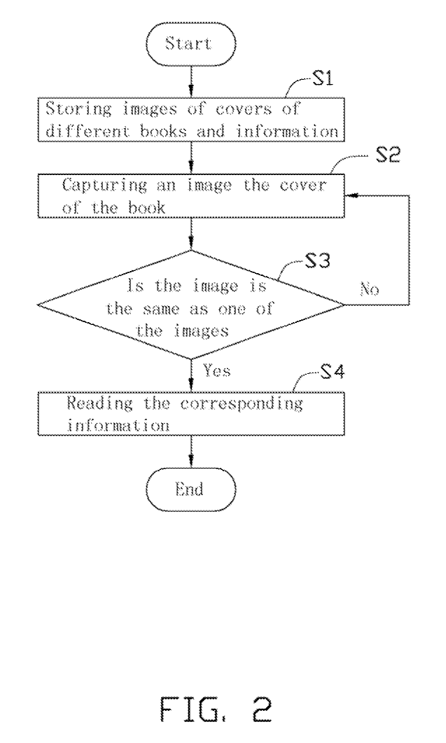

Referring to FIG. 2, an exemplary embodiment of a method for accessing product database includes the following steps.

In step S1, a plurality of images of covers of different books and information corresponding to each book are stored in the information storing module 15. The information corresponding to each book includes a name, an author, a publisher, a summary, and a web link of the book.

In step S2, the camera 10 is used to capture an image of a cover of a book. Then the processing unit 100 processes the image captured by the camera 10 such that the image is in a format to be compared to other images.

In step S3, the comparison module 16 compares the image processed by the processing unit 100 with the images stored in the information storing module 15 through the network module 12, to determine whether the image is the same as one of the images stored in the information storing module 15. If the image is the same as one of the images stored in the information storing module 15, step S4 is next. If the image is not the same as any image stored in the information storing module 15, return to step S2. In other words, a user needs to capture the cover of a next book.

In step S4, the reading module 18 reads information corresponding to the image. The information is displayed on a screen of the mobile phone.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A system for accessing product database, the system comprising:
a camera to capture an image of a product;
a processing unit connected to the camera; and
a storage unit connected to the processing unit and storing a plurality of programs to be executed by the processing unit, wherein the storage unit comprises:
an information storing module to store a plurality of images of different products and information corresponding to each product;
a comparison module, wherein the processing unit processes the image captured by the camera such that the image is in a format to be compared to other images, the comparison compares the image processed by the processing unit with the images stored in the information storing module to determine whether the image is the same as one of the images stored in the information storing module; and
a reading module to read information corresponding to the image when the image is the same as one of the images stored in the information storing module.

2. The system of claim 1, wherein the product is a book, the camera captures the image of a cover of the book, the plurality of images stored in the information storing module are the images of the covers of different books.

3. The system of claim 2, wherein the information of the book comprises a summary of the book.

4. A system for accessing product database, the system comprising:
a camera to capture an image of a product;
a processing unit connected to the camera;
a server connected to the processing and storing an information storing module, wherein the information storing module stores a plurality of images of different products and information corresponding to each product; and
a storage unit connected to the processing unit and storing a plurality of programs to be executed by the processing unit, wherein the storage unit comprises:
a network module;
a comparison module, wherein the processing unit processes the image captured by the camera such that the image is in a format to be compared to other images, the comparison compares the image processed by the processing unit with the images stored in the information storing module through the network module to determine whether the image is the same as one of the images stored in the information storing module; and
a reading module to read information corresponding to the image when the image is the same as one of the images stored in the information storing module.

5. The system of claim 4, wherein the product is a book, the camera captures the image of a cover of the book, the plurality of images stored in the information storing module are the images of the covers of different books.

6. The system of claim 5, wherein the information of the book comprises a summary of the book.

7. A method for accessing product database, the method comprising:
storing a plurality of images of different products and information corresponding to each product;
capturing an image of a product;
comparing the image captured by the camera with the stored images to determine whether the image is the same as one of the stored images; and
reading information of one product corresponding to the image when the image is the same as one of the stored images.

8. The method of claim 7, wherein the product is a book, the camera captures the image of a cover of the book, the plurality of images are the images of the covers of different books.

9. The method of claim 8, wherein the information of the book comprises a summary of the book.
